(19) United States
(12) Patent Application Publication
(10) Pub. No.: US 2004/0260425 A1
(43) Pub. Date: Dec. 23, 2004

(54) Fuel-pump controller

(76) Inventor: Miguel S Giacaman, San Francisco, CA (US)

Correspondence Address: LAW OFFICE OF JAY R. YABLON, 910 NORTHUMBERLAND DRIVE, SCHENECTADY, NY, 12309-2814, US

(21) Appl. No.: 10/491,325

(22) PCT Filed: Oct. 2, 2002
(86) PCT No.: PCT/US02/31639

(51) Int. Cl. G06F 17/00

(52) U.S. Cl. 700/239

(57) ABSTRACT

Disclosed herein is a dedicated pump controller apparatus for installation dedicated to and proximate a single fuel pump, comprising: at least one processor; data memory; and at least one fuel pump communications interface for communicating with said fuel pump. Further disclosed is a method for controlling fuel pumps using a dedicated pump controller comprising at least one processor and at least one data memory, comprising the steps of: installing a dedicated pump controller proximate to a single fuel pump; dedicating said dedicated pump controller to said single fuel pump; and communicating between said dedicated pump controller and said at least one fuel pump over at least one communications interface therebetween.

### FIELD OF THE INVENTION

This invention relates to the control of fuel pumps, and particularly to a dedicated pump controller that supplements or acts in lieu of the multi-pump pump controller used in present gas station configurations.

### BACKGROUND OF THE INVENTION

At present fuel pumps at gas stations are controlled by a “pump controller” equipment that interfaces one or more Point of Sale terminals (POS's) with one or more fuel pumps, typically one POS for anywhere from 4 to 16 pumps. This architecture possesses several drawbacks. If the POS or pump controller fails, becomes busy, overloaded or experiences communication problems then the fuel pumps are unable to function (deliver fuel) since they depend upon communication with the pump controller to receive the appropriate commands, e.g. authorization, pump start, retrieving of the transaction data and real time volume and amount. Further, all communications with the pumps are funneled through a single pump controller using one or two serial communication links. On each link only one pump can be addressed at a time creating a communications bottleneck.

When the control system fails due to failure of the POS, controller, or wiring, all the pumps connected to a link stop fueling. A common practice in response to these events (loss of control due to controller system failure) is to set the fuel dispensers into a “stand alone” mode in which they function autonomously from a control system.

The main disadvantage of this practice is the lack of logging or recording of the fuel dispensed and associated data like: total amount, price per volume unit (price per litter), type of fuel (e.g. gasoline 91 octane) time and date, pump number assigned in a particular gas station, etc.

Another major limitation is the lack of issuance of a receipt for the customer, and the lack of a recording of the associated information for later tax and financial management.

Another limitation of prior art is that main pump controller are typically very expensive fixed cost items, any must be employed regardless of how many pumps are at the gas station. Thus, for example, a station operator with only two pumps pays four times as much for main pump controller, per pump, as a station operator with eight pumps.

### SUMMARY OF THE INVENTION

Disclosed herein is a dedicated pump controller apparatus for installation dedicated to and proximate a single fuel pump, comprising: at least one processor; data memory; and at least one fuel pump communications interface for communicating with said fuel pump.

Further disclosed is a method for controlling fuel pumps using a dedicated pump controller comprising at least one processor and at least one data memory, comprising the steps of: installing a dedicated pump controller proximate to a single fuel pump; dedicating said dedicated pump controller to said single fuel pump; and communicating between said dedicated pump controller and said at least one fuel pump over at least one communications interface therebetween.

### BRIEF DESCRIPTION OF THE DRAWING

The features of the invention believed to be novel are set forth in the appended claims. The invention, however, together with further objects and advantages thereof, may best be understood by reference to the following description taken in conjunction with the accompanying drawing(s) in which:

FIG. 1 is a schematic plan view illustrating a dedicated pump controller in accordance with the invention, as it fits in connection with a fuel pump and the other components of a typical gas station configuration.

FIG. 2 is a schematic plan view illustrating the dedicated pump controller of FIG. 1 in a particular embodiment where it is used to drive pump printers.

FIG. 3 is a schematic plan view illustrating the dedicated pump controller of FIG. 2, as it fits in connection with a fuel pump and the other components of a typical gas station configuration.

### DETAILED DESCRIPTION OF THE INVENTION

A dedicated pump controller installed, one per fuel pump, proximate and in connection with each said fuel pump, is capable of functioning as a pump controller dedicated solely to the pump for which it is installed. This dedicated pump controller contains a microcomputer with a (brand-specific) pump communications interface and optionally a communications interface with a conventional (remote or external) main pump controller, which is non-dedicated and has control over one or more pumps at the gas station. If connected to such a main pump controller, the device may function as a slave to this main pump controller. Otherwise it may function autonomously to control the fuel pump on its own.

As used herein, a “fuel pump” is to be understood as a device useful for introducing liquid fuel into vehicles (e.g., car and truck) fuel tanks. This fuel pump must be able to measure at least the volume or amount dispensed. It may be a single or dual unit, e.g. able to execute one or two fuelings simultaneously with independent measurement. Most of the pumps in use are dual (two-sided) units with which vehicle drivers are very familiar.

As used herein, “dedicated” is understood to mean that each dedicated pump controller is exclusively dedicated to a single (single or dual-sided) fuel pump,

As used herein, “proximate” and “in connection with” are understood to mean that the “proximate” pump controller is located either inside the fuel pump, or is directly upon or next to the pump, and to exclude the situation where the pump controller is, for example, located inside the building structure at the gas station and connected to the pump via some form of wiring.

This dedicated pump controller may also comprise one or more communication ports to interface and communicate with other devices installed “in” or “on” the pump such as receipt printers, credit card or other readers, keypads, displays, modems, local authorization consoles, etc.

The dedicated pump controller comprises a microcomputer and this ‘by definition’ includes at least one CPU (central processing unit), program memory and data memory. The latter may be used to store information concerning the fueling operation in either master (independent of the main pump controller) or slave (controlled by the main pump controller) modes.

This information may be kept in the memory as long as needed and retrieved by any device able to establish communication with this dedicated pump controller including but not limited to an external non-dedicated controller, or other alternative computerized device such as a notebook computer. This information may also be cumulative, representing one or more fueling process, thereby becoming a transaction log.

Such logging may include volume dispensed, price per volume unit (e.g. gallons or liters), amount (e.g. dollars and cents) dispensed, type of fuel (e.g. diesel or gasoline 91 octane's), time and date, pump identification (e.g. pump number assigned in one particular site) and any other information that the management may want to include.

That information or part of it may be retrieve later by a point of sale terminal, computer or any device able to establish communication with this dedicated pump controller.

A dedicated pump controller for a single fuel pump that goes inside the pump needs a very simple enclosure, if any, may use the fuel pump's power supply voltage saving having its own power converter, and it has a simplified communication interface just for one pump. As such, this is a low cost solution particularly suited to service stations with a small number of pumps. Considering that there is one dedicated pump controller for each pump its cost is proportional to the number of fuel pumps to be controlled.

A preferred embodiment of the dedicated pump controller comprise the following functionality: 1) Automatically printing receipts once the fueling operation is completed at fueling point, controlled by the dedicated pump controller rather than the main pump controller. 2) Maintaining a transaction log of a plurality of transactions per fueling point. 3) Comprising real time clock. 4) Storing setup parameters and transaction data in memory. 5) In those installations where a main pump controller is required, the dedicated pump controller must operate without causing conflict. 6) It comprises the capability to setup system parameters, receive information, upgrade application software, and retrieve sales information via an RS232 port connected, for example, to a notebook computer or similar alternative computerized device. 7) It has duplicate receipt means (e.g., a depressible button) for issuing a duplicate receipt of the last transaction for that particular fueling point. 8. It has shift summary means (such as a “SHIFT” button) that when activated will issue a shift summary report.

If the main pump controller or POS is out of order, or voluntarily or involuntarily disconnected from the dedicated pump controller, the dedicated pump controller will control and record all sales occurring at the pump to which it is dedicated. When the main pump controller or POS is back in order or reconnected, all data collected in the dedicated pump controller may be uploaded to the main pump controller.

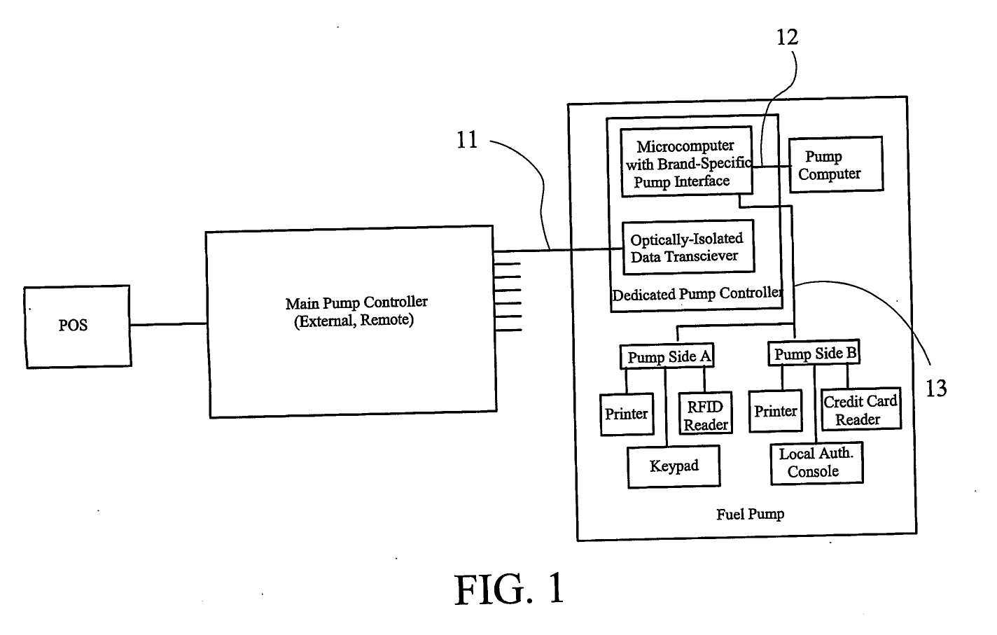

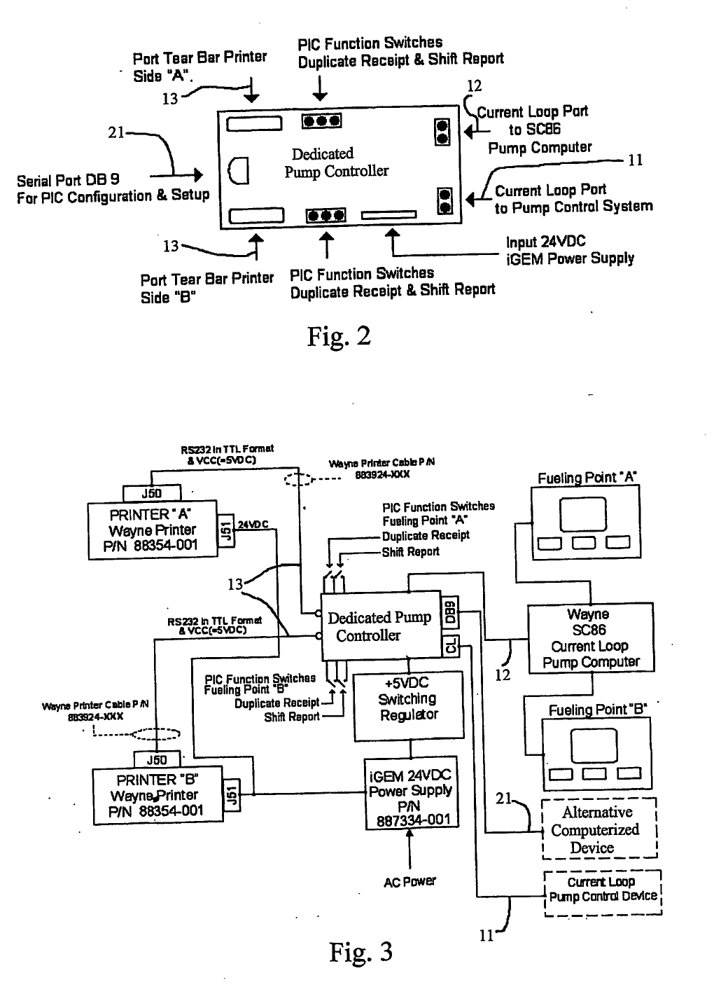

Reference numbers 11, 12, 13 and 21 highlight the correspondences among the connections illustrated in FIGS. 1, 2, and/or 3.

While only certain preferred features of the invention have been illustrated and described, many modifications and changes will occur to those skilled in the art. It is, therefore, to be understood that the appended claims are intended to cover all such modifications and changes as fall within the true spirit of the invention.

We claim:

1. A dedicated pump controller apparatus for installation dedicated to and proximate a single fuel pump, comprising:
at least one processor;
data memory for storing transaction information regarding fueling operations of said fuel pump in said data memory, independently of said main pump controller;
at least one fuel pump communications interface for communicating with said fuel pump; and
fuel pump control means for controlling dispensing operations of said fuel pump via a pump computer associated therewith, over said at least one fuel pump communications interface, independently of a main pump controller.

2. The apparatus of claim 1, further comprising:
at least one peripheral device communications interface for communicating with at least one peripheral device connected with said fuel pump.

3. The apparatus of claim 1, further comprising:
at least one main pump controller communications interface for communicating with said main pump controller.

4. The apparatus of claim 3, further comprising:
main fuel pump control means for said main pump controller to control said fuel pump via said dedicated pump controller.

5. The apparatus of claim 3, further comprising:
main data receipt means for data associated with said pump to be sent to said main pump controller via said dedicated pump controller.

6. The apparatus of claim 1, further comprising:
data recording means for recording at least one data item received over said at least one fuel pump communications interface.

7. The apparatus of claim 2:
said at least one peripheral device comprising a receipt printer.

8. The apparatus of claim 2, further comprising:
peripheral device functional selection means for selecting a function to be performed by said at least one peripheral device.

9. The apparatus of claim 8:
said peripheral device comprising a printer; and
said peripheral device functional selection means causing said printer to print a to print a first receipt.

10. The apparatus of claim 8:
said peripheral device comprising a printer; and
said peripheral device functional selection means for causing said printer to print a to print a duplicate receipt.

11. The apparatus of claim 8:
said peripheral device comprising a printer; and
said peripheral device functional selection means for causing said printer to print a to print a shift summary.

12. The apparatus of claim 8:
said peripheral device comprising a printer; and
said peripheral device functional selection means for causing said printer to print a to print a transaction log.

13. The apparatus of claim 2:
said at least one peripheral device comprising a printer for printing data stored in said data memory.

14. The apparatus of claim 3, further comprising:
inactive state control and data accumulation means for enabling said dedicated pump controller apparatus to control said fuel pump and accumulate data from said fuel pump when said main pump controller communications interface is inactive; and
post-reactivation communications means enabling data stored in said data memory to be communicated to said main pump controller once said main pump controller communications interface has been reactivated.

15. The apparatus of claim 3, further comprising:
alternative communications means for communicating with an alternative computerized device in lieu of communicating with said main pump controller.

16. The apparatus of claim 15, further comprising:
alternative programming means for programming said dedicated pump controller using said alternative computerized device via said alternative communications means.

17. The apparatus of claim 15, further comprising:
alternative uploading means for uploading data from said dedicated pump controller to said alternative computerized device via said alternative communications means.

18. A method for controlling fuel pumps using a dedicated pump controller comprising at least one processor and at least one data memory, comprising the steps of:
installing a dedicated pump controller proximate to a single fuel pump;
dedicating said dedicated pump controller to said single fuel pump;
communicating between said dedicated pump controller and said at least one fuel pump over at least one communications interface therebetween;
controlling dispensing operations of said fuel pump via a pump computer associated therewith, over said at least one fuel pump communications interface, independently of a main pump controller; and
storing transactional information regarding fueling operations of said fuel pump in said data memory, independently of said main pump controller.

19. The method of claim 18, further comprising the step of:
communicating between said dedicated pump controller and at least one peripheral device connected with said fuel pump using at least one peripheral device communications interface.

20. The method of claim 18, further comprising the step of:
communicating between said dedicated pump controller and said main pump controller over at least one main pump controller communications interface.

21. The method of claim 20, further comprising the step of:
said main pump controller controlling said fuel pump via said dedicated pump controller.

22. The method of claim 20, fiber comprising the step of:
sending data associated with said pump to be sent to said main pump controller via said dedicated pump controller.

23. The method of claim 18, further comprising the step of:
recording at least one data item received over said at least one fuel pump communications interface.

24. The method of claim 19, said at least one peripheral device comprising a receipt printer, further comprising the step of:
printing a receipt on said receipt printer using said at least one peripheral device communications interface.

25. The method of claim 19, further comprising the step of:
selecting a function to be performed by said at least one peripheral device using a peripheral device functional selection means therefor.

26. The method of claim 25, said peripheral device comprising a printer, further comprising the step of:
causing said printer to print a to print a first receipt using said peripheral device functional selection means.

27. The method of claim 25, said peripheral device comprising a printer, further comprising the step of:
causing said printer to print a to print a duplicate receipt using said peripheral device functional selection means.

28. The method of claim 25; said peripheral device comprising a printer, further comprising the step of:
causing said printer to print a to print a shift summary using said peripheral device functional selection means.

29. The method of claim 25, said peripheral device comprising a printer, further comprising the step of:
causing said printer to print a to print a transaction log using said peripheral device functional selection means.

30. The method of claim 25, said peripheral device comprising a printer, further comprising the step of:
printing data stored in said data memory.

31. The method of claim 20, further comprising the steps of:
controlling said fuel pump and accumulating data from said fuel pump with said dedicated pump controller when said main pump controller communications interface is inactive; and
communicating data stored in said data memory to said main pump controller once said main pump controller communications interface has been reactivated.

32. The method of claim 20, further comprising the step of:
communicating with an alternative computerized device in lieu of communicating with said main pump controller, using alternative communications means therefor.

33. The method of claim 32, further comprising the step of:
programming said dedicated pump controller using said alternative computerized device via said alternative communications means.

34. The method of claim 32, further comprising the step of:
uploading data from said dedicated pump controller to said alternative computerized device via said alternative communications means.

35. A fuel pump control system, comprising:
at least one dedicated pump controller installed in a manner dedicated to and proximate a single fuel pump;
a main pump controller connected with at least one of said dedicated pump controllers;
master fuel pump control means for enabling each said dedicated pump controller to control its said fuel pump via a pump computer associated therewith, independently of said main pump controller;
slave fuel pump control means for enabling each said dedicated pump controller to control its said fuel pump via a pump computer associated therewith, based upon control by said main pump controller;
data recoding means for recording within each said dedicated pump controller, data received by each said dedicated pump controller from its said fuel pump; and
data transmission means for transmitting said data received by each said dedicated pump controller, to said main pump controller.

36. The apparatus of claim 1, said pump control means additionally for controlling dispensing operations of said fuel pump via said pump computer, over said at least one fuel pump communications interface, interdependently with said main pump controller.

37. The method of claim 18, further comprising the step of:
controlling dispensing operations of said fuel pump via said pump computer, over said at least one fuel pump communications interface; interdependently with said main pump controller

38. The apparatus of claim 2:
said at least one peripheral device comprising a card reader.

39. The apparatus of claim 2:
said at least one peripheral device comprising an RFID reader.

40. The apparatus of claim 2:
said at least one peripheral device comprising a keypad.

41. The apparatus of claim 2:
said at least one peripheral device comprising a local authorization console.

42. The apparatus of claim 2:
said at least one peripheral device comprising a device for gathering information pertaining to fueling transactions.

43. The method of claim 19, said at least one peripheral device comprising a card reader, further comprising the step of:
reading a card with said card reader using said at least one peripheral device communications interface.

44. The method of claim 19, said at least one peripheral device comprising an RFID reader, further comprising the step of:
reading an RFID with said an RFID reader using said at least one peripheral device communications interface.

45. The method of claim 19, said at least one peripheral device comprising a keypad, further comprising the step of:
reading information keyed into said keypad using said at least one peripheral device communications interface.

46. The method of claim 19, said at least one peripheral device comprising a local authorization console, further comprising the step of:
reading information from said local authorization console using said at least one peripheral device communications interface.

47. The method of claim 19, said at least one peripheral device comprising a device for gathering information pertaining to fueling transactions, further comprising the step of:
gathering said information pertaining to fueling transactions using said device for gathering information pertaining to fueling transactions.

48. The apparatus of claim 1, father comprising:
data recording means for recording at least one data item received over at least one peripheral device communications interface for communicating with at least one peripheral device connected with said fuel pump.

49. The method of claim 18, further comprising the step of:
recording at least one data item received from at least one peripheral device connected with said fuel pump using at least one peripheral device communications interface.
